(19) United States
(12) Patent Application Publication
(10) Pub. No.: US 2019/0102470 A1
(43) Pub. Date: Apr. 4, 2019

(54) People search based on collateral features

(71) Applicant: World Biographic Encycopedia, Inc., New York, NY (US)

(72) Inventor: Valery Tsepkalo, Minsk (BY)

(73) Assignee: Valery Tsepkalo, Minsk (BY)

(21) Appl. No.: 15/732,181

(22) Filed: Oct. 2, 2017

(51) Int. Cl. G06F 17/30

(52) U.S. Cl. CPC G06F 17/30867; G06F 17/30386

(57) ABSTRACT

1. Methods, systems, and apparatus, including computer programs encoded on computer storage media, for finding electronic resources for person names associated with an object searched (linked to it). In one embodiment, a search query is received. A listing of unique person names with their brief profiles associated with the search query is generated. A person name is selected from the list of the unique person names based on a decision of a user. The search query is updated by merging the initial request and the selected person profile. A listing of electronic resources meeting the latter search query is generated for presentation on a user interface. The listing includes resources associated with a particular person in association with the initial request.

2. The methods, systems, and apparatus of claim 1 further allowing to combine catalogues' fields like Actor or Economist from the Activity catalogue, American or French from the Nationality catalogue, Arab or Slavic from Ethnicity catalogue, Baptist or Catholic from Religious Affiliation catalogue, and so on for such catalogues as Awards, Political Party, Membership, Alma Mater, and to search for a list of unique persons meeting the request aggregated from the catalogues.

### BACKGROUND

This specification relates to searches of network-accessible resources that include references to the subject searched linked to named people.

Search engines can help users gather information about the searched object associated with the object search query. For instance, users can enter a search query, i.e. a title of work, or address, or just a word as part of a search query. Existing search engines can return search results, including listings of resources, satisfying the search. Depending on the search algorithms employed by the search engine, resources identified in the set of search results can each include a mention of the searched object somewhere in the resource.

Search engines in a case of looking for particular person whose name is known can generate the listing of links to resources about a certain person.

When search engines return listings of person names in response to a particular personal name the listings often contain references to duplicated person names because the number of resources devoted to a famous person significantly overshadow others.

At the moment none of the existing search engines can search people based on collateral characteristics. For example, if one would like to find ‘Duke University, Orthodox’ the search engines provide lists of fellowships, churches, religious communities and organizations, etc. but not people linked or associated to the request.

If someone wants to search for people associated with an object there is no existing algorithm which can satisfy the user request.

The problem can be solved by using a database of person profiles containing structured information on maximum number of available people. The database includes catalogues containing such fields as places of birth and death (if applicable), activity, nationality, ethnicity, alma mater, awards, political party, religious affiliation, and membership. The system depending on the type of search request searches either the database for a list of unique persons associated with the combination of the catalogues or looks through persons' profile descriptions for an object searched. The database of person profiles represents a key intermediate layer in the search system.

While creating the database of person profiles one have to collect publicly available data on people, process the data to get structured information on persons, merge different data sets on each unique person, and record them to the database.

### SUMMARY

This specification describes technologies relating to searching of network-accessible resources that include references to the queried subject linked to named people.

In general, one aspect of the subject matter search described in this specification can be embodied in methods that include the actions of generating, by operation of a computer system, a plurality of unique person names with profiles as a result of a search query.

Each person profile contains a structured description of the person, i.e. names, date and place of birth (and death), education, activities, religious affiliation and political views, list of works, awards and achievements, etc., recorded in special distinct fields. Information for the person profiles is collected from publicly available data from different sources of information on people such as online and offline publications, books, encyclopedias, Who's Who, web resources.

Profile fields like Geographical Locations, Activity, Nationality, Ethnicity, Alma Mater, Awards, Political Party, Religious Affiliation, and Membership include catalogues. The catalogues contain sets of entities defined by the fields, e.g. catalogue Activity includes entities like Writer, Educator, Player, Executive, Singer, Actor, etc. The catalogues are used to select unique persons according to the query request and the catalogues define the structure of the database of person profiles. The database represents a key intermediate layer in the claimed method of the search system.

These and other embodiments can each optionally include one or more of the following features, alone or in combination. A search query can be received and a set of search results generated adapted for presentation on a user interface. The set of search results is represented by a listing of person names with the part of the profiles, where the search query is contained. The list of profiles is generated from a profile database on the basis of the search query and person identities.

A person name is selected from the list of the unique person names based on a decision of a user. The decision on identification of a person name relies on a user and depends on a predetermined (or relevant) proximity with the initial search query.

The search query is updated by merging the person identity with the initial request. The results of the latter search query can include a listing of resources associated with the initial query and the person identity corresponding to the particular person name selected.

Implementations may include systems, methods, software products, and machine-readable media storing instructions for causing data processing apparatus to perform operations. The details of one or more implementations are set forth in the accompanying drawings and the description below. Other features will be apparent from the description and drawings, and from the claims.

### DESCRIPTION OF THE DRAWINGS

FIG. 1 is a schematic diagram of an example system for generating a listing of electronic resources associated with the particular person name and a search query.

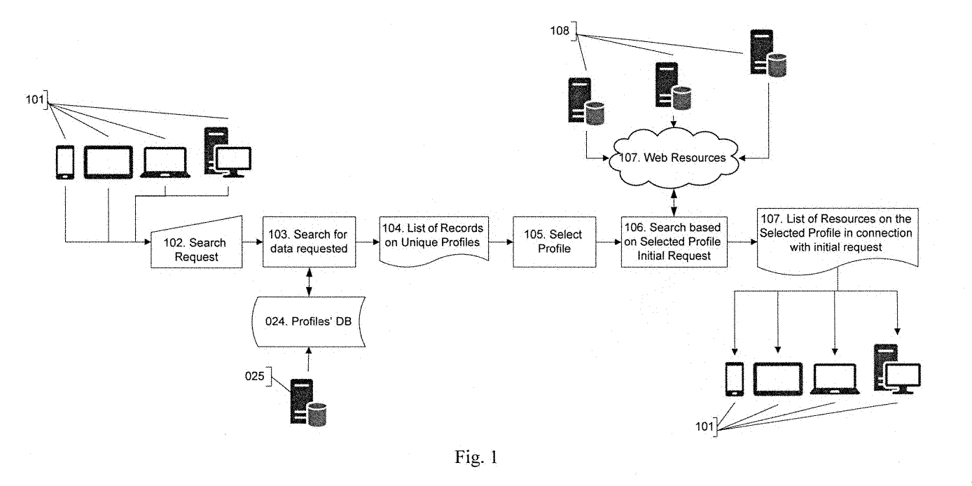

FIG. 2 is a schematic diagram of an example system for generating a database of person profiles containing structured information on each person recorded. Every profile corresponds to a unique person.

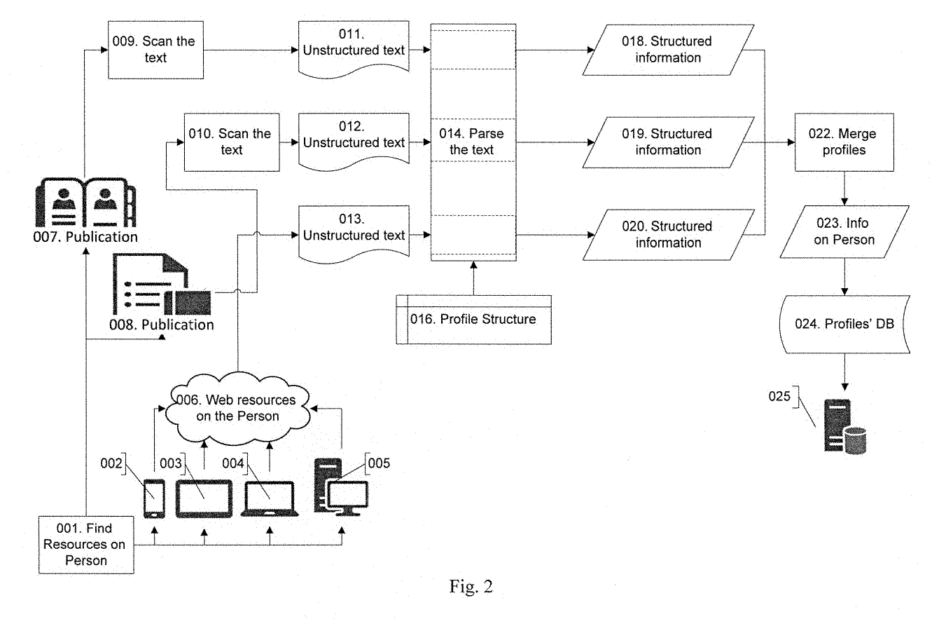

FIG. 3 is a schematic information structure of the person profile used for a generation of a listing of unique person names associated with the search query.

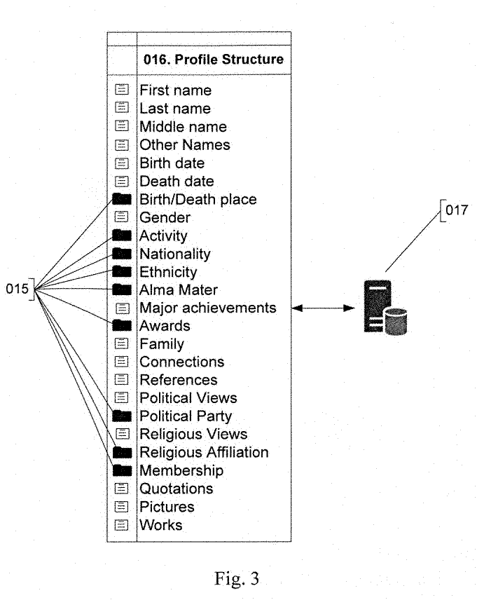

FIG. 4 is a table of optional search query combinations made from the profile structure fields. The profile fields includes catalogues containing lists of instances, e.g. list of activities, list of nationalities, list of political parties, etc.

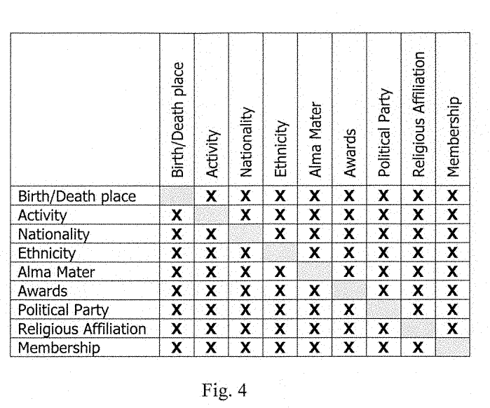

FIG. 5. An example listing of unique person names associated with the search query combined from 3 catalogues: Nationality (American), Activity (Military), and Alma Mater (West Point).

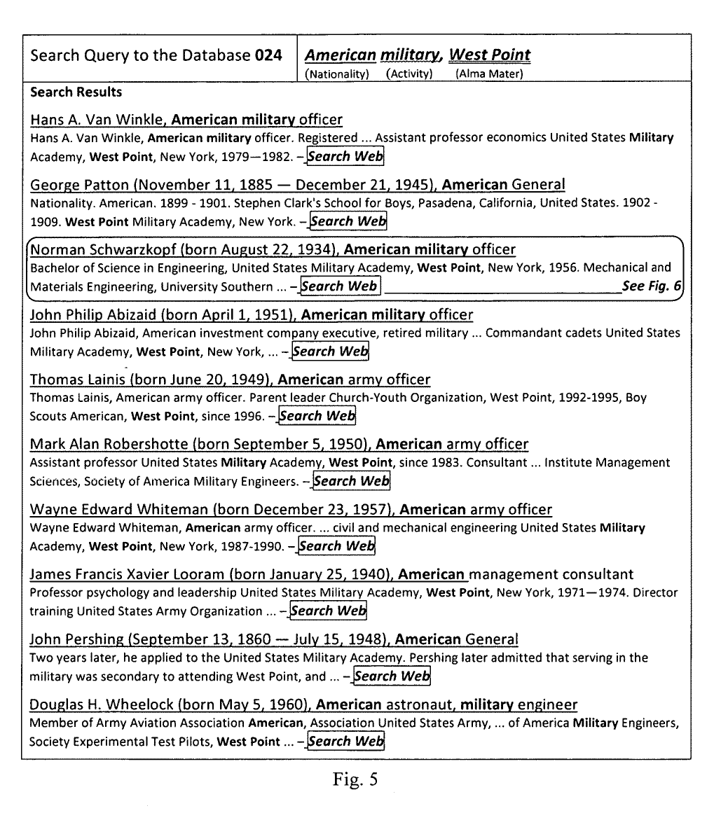

FIG. 6. An example listing of results for further search on the Web for ‘Norman Schwarzkopf, American military, West Point’.

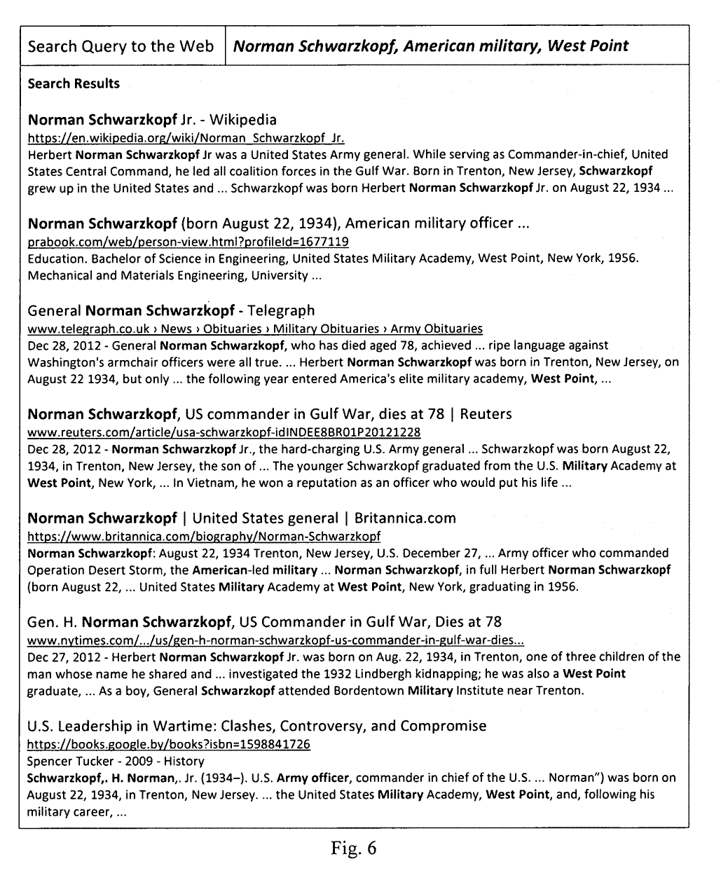

FIG. 7. An example listing of unique person names associated with the search query combined from 3 catalogues: Nationality (German), Activity (Politician), and Religious Affiliation (Catholic).

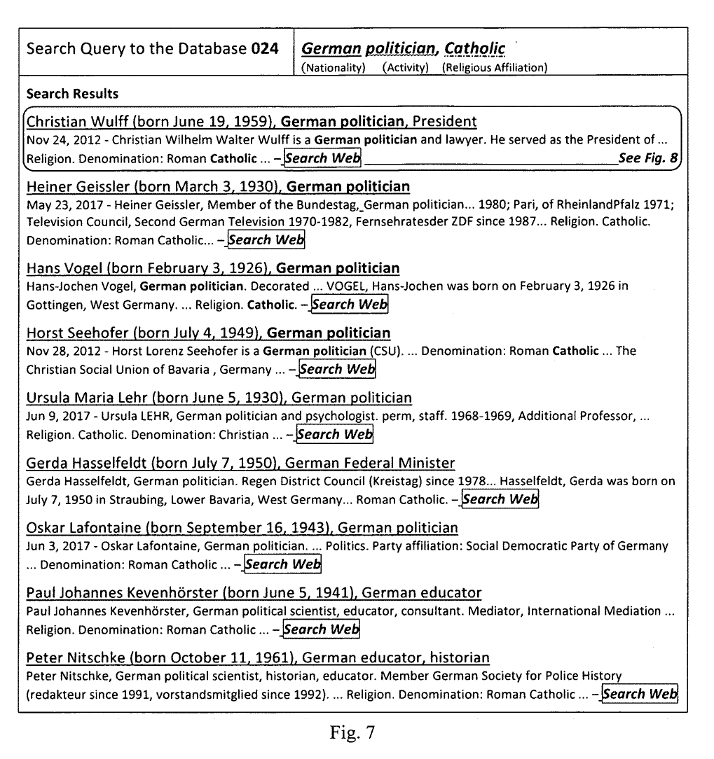

FIG. 8. An example listing of results for ‘Search Web’ for ‘Christian Wulff, German politician, Catholic’.

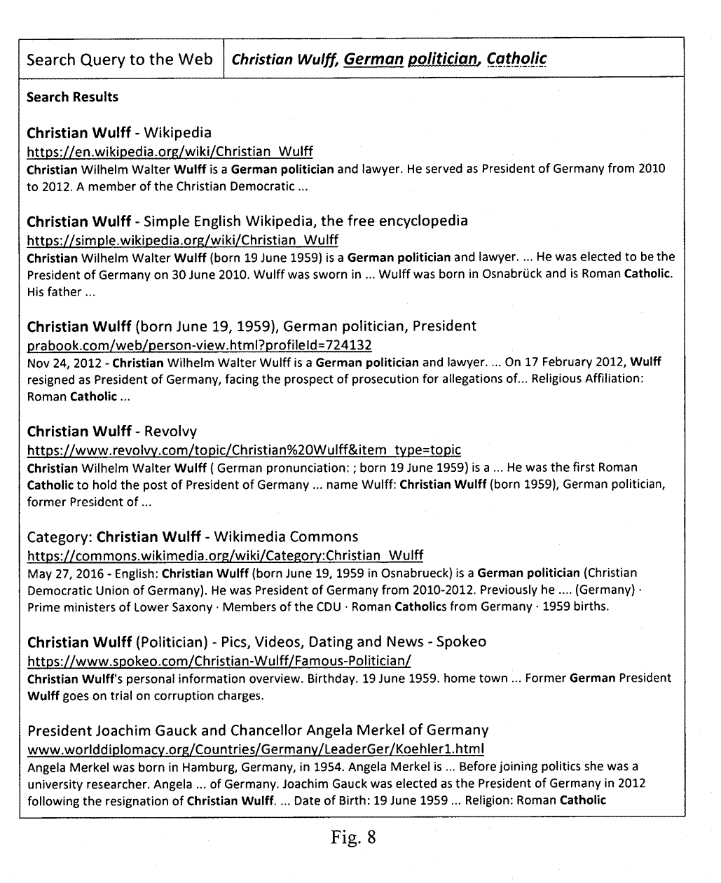

FIG. 9. An example listing of a conventional search results for a query of ‘Invasion of Normandy’.

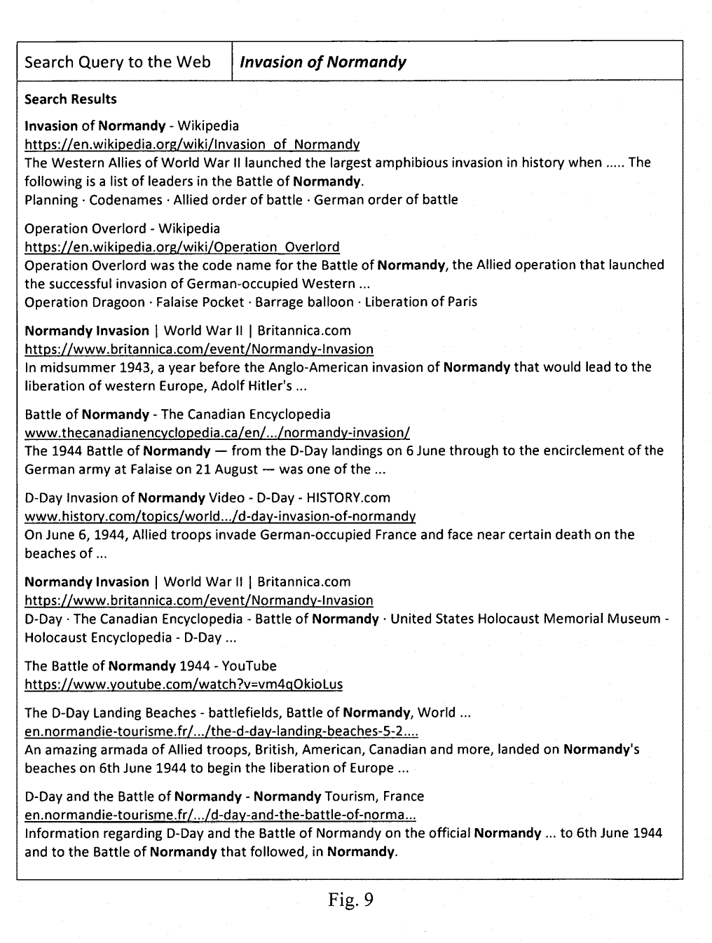

FIG. 10. An example listing of unique person names associated with the search query of ‘Invasion of Normandy’ in the claimed method.

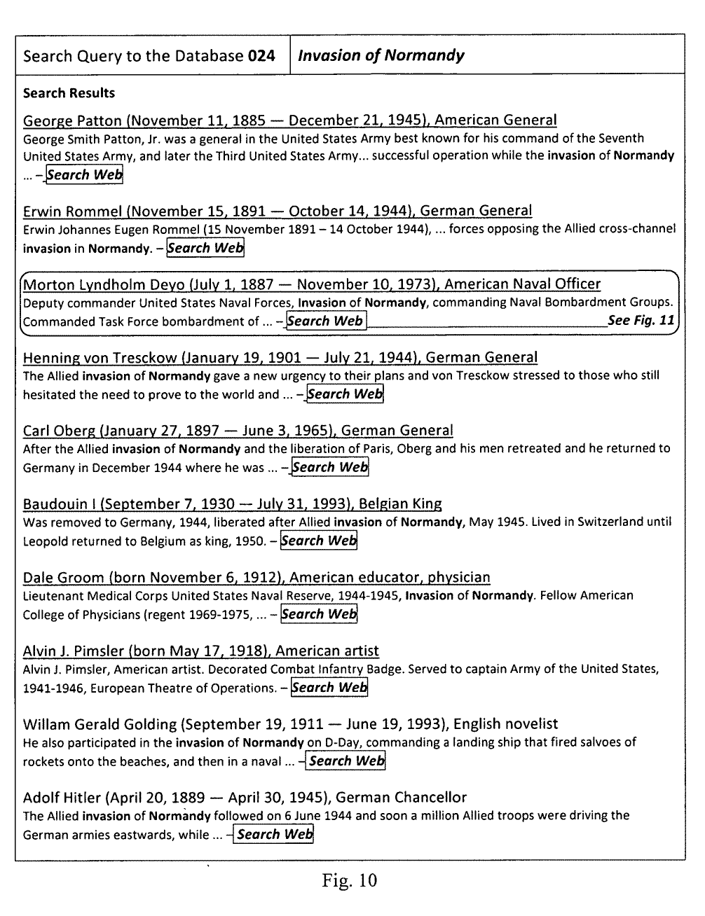

FIG. 11. An example listing of further search results for a query of ‘Morton Lyndholm Deyo, American Naval Officer, Invasion of Normandy’.

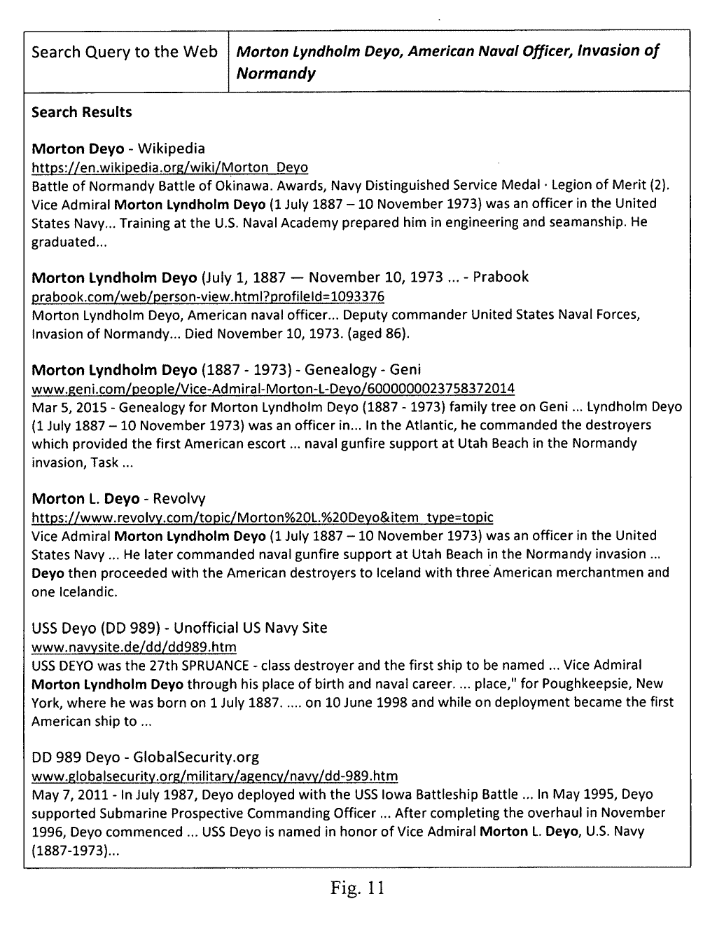

FIG. 12. An example listing of unique person names associated with the search query of ‘Vienna Opera’ in the claimed method.

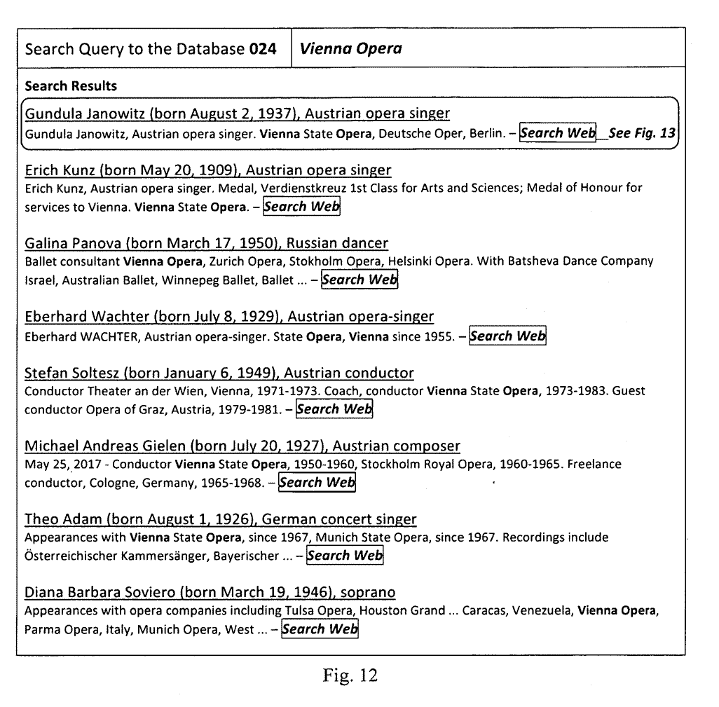

FIG. 13. An example listing of further search results for a query of ‘Gundula Janowitz, Austrian opera singer, Vienna Opera’.

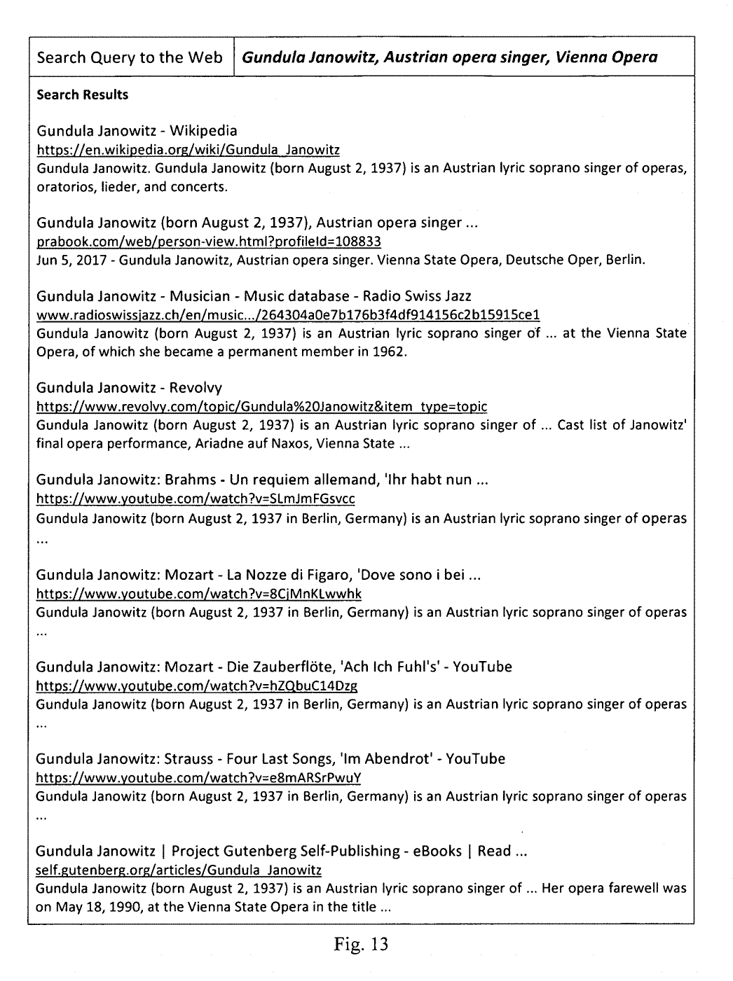

FIG. 14. An example listing of web search query of ‘George Washington’ in existing search engines.

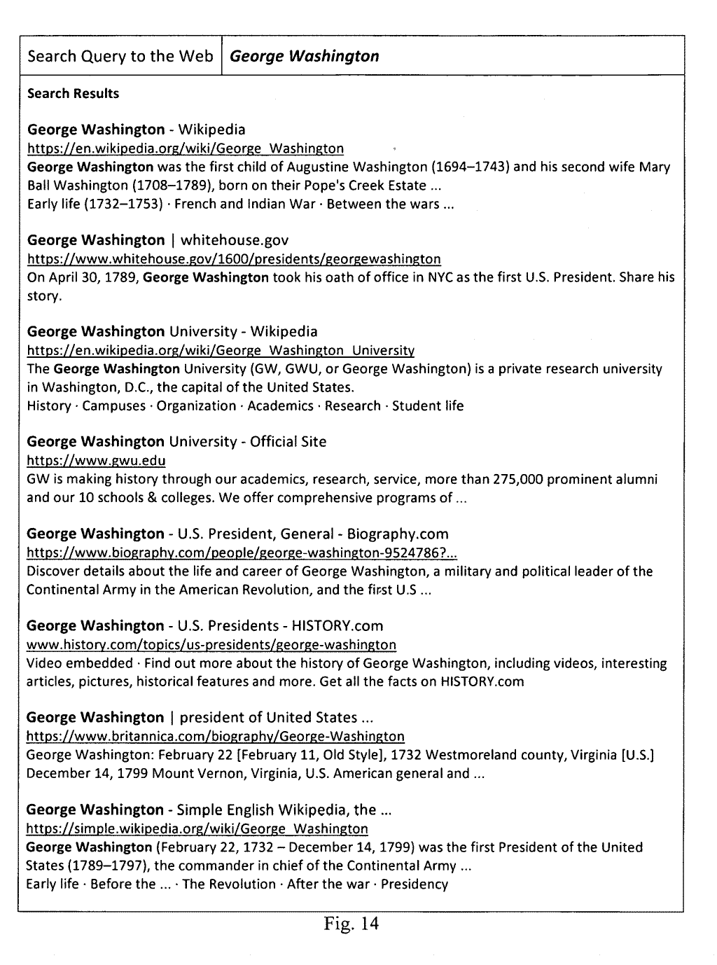

FIG. 15. An example listing of unique person names associated with the search query of ‘George Washington’ in the claimed method.

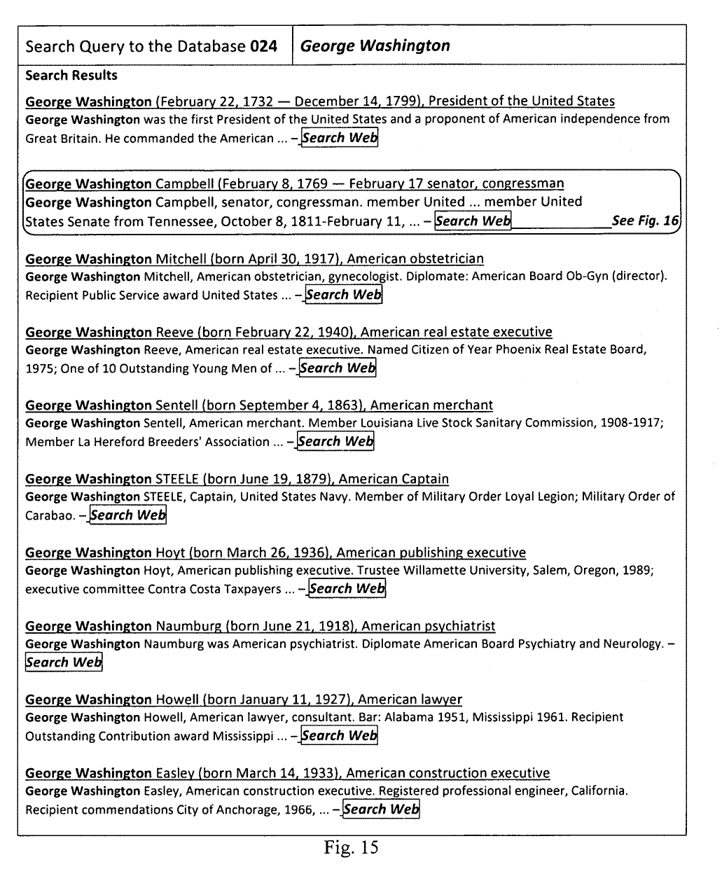

FIG. 16. An example listing of further web search of ‘George Washington Campbell, senator, congressman’.

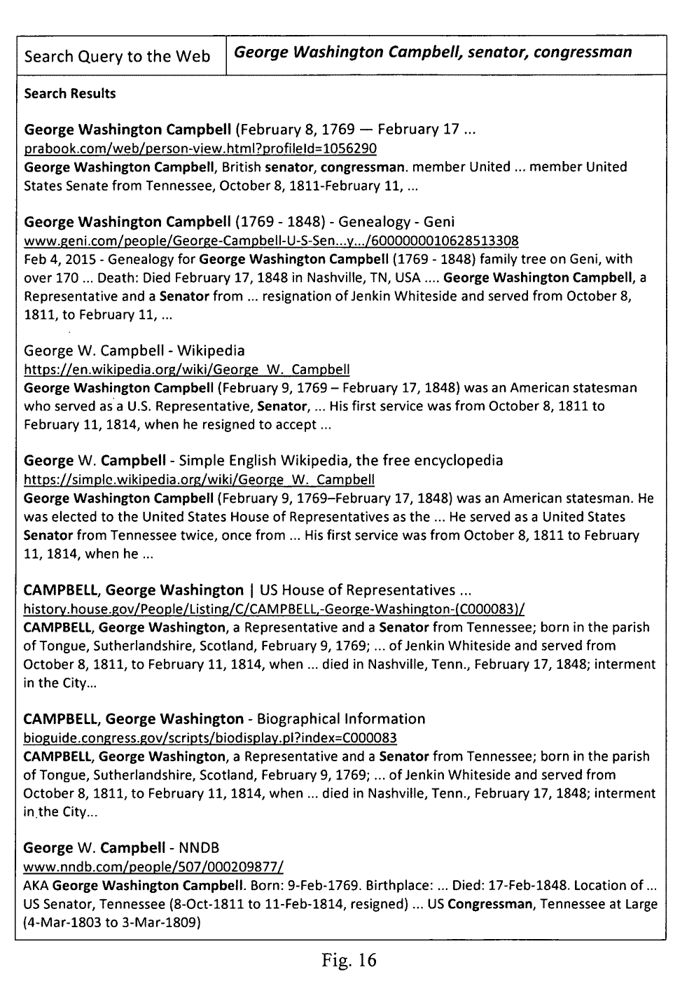

### DETAILED DESCRIPTION

In response to a search query 102 entered by a user, using any of devices 101 connected to the Internet, a search engine 103 can generate a listing of people for the search query 104. This listing of people can be presented to a user instead of a list of digital resources typically returned in response to a search query. This listing of people can convey to the user person names most closely associated with the search query. Such a listing can be generated in response to any search subject entered by a user or system, including a name of a person or any substance or notion, such as work of art, city, company, profession, event or product. This list of names satisfying the search query 102 can be generated from a preliminary created database of person profiles 024, stored on a server 025.

On receiving the search request 102 the system depending on a type of the query searches the database 024 for the list of unique persons who is associated with the combination of the catalogues 015 or the system looks through persons' profile descriptions in the database 024 for an object searched.

A list of records on unique profiles 104 is constructed from the returned resources resulting from the search for data requested 103. Person names appear on a user interface. Based on a decision of a user a particular person is selected from the list of people 105. The decision on identification of person names would rely on a predetermined proximity with the initial search query.

The search query is updated by merging the initial request and person identities from the selected person profile 106. The results of the latter search query can include a listing of resources associated with the initial query and the person identities corresponding to the particular person name selected 107. The search results can be presented on any electronic device 101 connected to the Internet.

The database of person profiles 024 contains records on unique persons. The records are made by collecting publicly available data on people from different sources. The sources include but not limited to online and offline publications 008, books 007, web recourses 006. Offline publications and books are scanned 009-010 and transformed into electronic files representing unstructured texts 011-013. The unstructured texts are parsed 014 to get structured information on a given person 018-020. The structure of the information is defined by a profile structure 016.

The profile structure is defined by catalogues 015 containing such fields as places of birth and death (if applicable), dates of birth and death, nationality, ethnicity, religious affiliation, education (Alma Mater), activity, award, membership, etc. The catalogues include files 017 containing list of cities, countries, ethnicities, nationalities, universities, etc.

On getting structured information on a given person 018-020 it is checked whether the information from different sources relate to the same person. Such structured information on a given person 018-020 extracted from different sources represent interim profiles. If all interim profiles 018-020 describe the same person the structured information from different sources is merged 022. By merging 022 interim profiles one gets more detailed person profile 023. The people search is based on the profile database 024 located on a server 025.

While this specification contains many implementation details, these should not be construed as limitations on the scope of any invention or of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described program components and systems can generally be integrated together.

Thus, particular implementations of the subject matter have been described. Other implementations are within the scope of the following claims. In some cases, the actions recited in the claims can be performed in a different order and still achieve desirable results.

The description relates to particular embodiments of the claimed method. The following claims define scope for other embodiments.

What is claimed is:

1. A method of searching people on the Internet based on collateral features (e.g. American-Military-West Point), or to find links between people and any given subject (for example, ‘Vienna Opera’), or historic events or facts (e.g. ‘Invasion of Normandy’), comprising:
the first phase in the searching includes a query to the database of person profiles, the search system returns a list of people whose profiles contain (or relate to) records with the subject searched;
the second phase is to merge the search subject and a person name selected by a user, outcomes of the phase are Internet websites containing both the search subject and the person name (including basic information on the person).

2. The method of claim 1 is carried out by creating an intermediate layer in the search system in a form of a database of person profiles that are unified and structured in the same way.

3. The method of claim 2 is implemented by extracting information about a certain person from publicly available sources, parsing it in accordance to a standard structure, merging the information into one profile, and saving the information about a person into a database.
